(19) United States
(12) Patent Application Publication
(10) Pub. No.: US 2017/0248484 A1
(43) Pub. Date: Aug. 31, 2017

(54) PRESSURE SENSOR, PRODUCTION METHOD FOR PRESSURE SENSOR, ALTIMETER, ELECTRONIC APPARATUS, AND MOVING OBJECT

(71) Applicant: SEIKO EPSON CORPORATION, Tokyo (JP)

(72) Inventor: Shinichi YOTSUYA, Chino-shi (JP)

(73) Assignee: SEIKO EPSON CORPORATION, Tokyo (JP)

(21) Appl. No.: 15/433,046

(22) Filed: Feb. 15, 2017

(30) Foreign Application Priority Data
Feb. 26, 2016 (JP) 2016-036184

(51) Int. Cl. G01L 9/00; G01L 19/14

(52) U.S. Cl. CPC G01L 9/0052; G01L 19/148

(57) ABSTRACT

A pressure sensor includes an SOI substrate which has a first silicon layer, a second silicon layer placed on one side of the first silicon layer, and a silicon oxide layer placed between the first and second silicon layers, and a concave section which opens to the surface on the first silicon layer side of the SOI substrate, wherein in a plan view of the SOI substrate, a portion overlapping the concave section of the SOI substrate becomes a diaphragm which is flexurally deformed by receiving a pressure, and the second silicon layer is exposed on the bottom surface of the concave section.

### BACKGROUND

1. Technical Field

The present invention relates to a pressure sensor, a production method for a pressure sensor, an altimeter, an electronic apparatus, and a moving object.

2. Related Art

There has been known a configuration described in WO 2009/041463 (Patent Document 1) as a pressure sensor. The pressure sensor described in Patent Document 1 includes an SOI substrate in which a concave section is formed and a portion overlapping the concave section becomes a diaphragm, and a base substrate bonded to the SOI substrate so as to close the opening of the concave section, and is configured to measure a pressure by detecting the flexural deformation of the diaphragm by receiving the pressure with a piezoelectric element placed in the diaphragm.

However, in the pressure sensor having such a configuration, the diaphragm has a stacked structure of a silicon oxide layer and a silicon layer. The linear expansion coefficient is greatly different between the silicon layer and the silicon oxide layer, and due to the difference in the linear expansion coefficient, the internal stress of the diaphragm greatly changes depending on the environmental temperature. Therefore, there is a problem that a hysteresis in which even if the same pressure is received, the measured value varies depending on the environmental temperature occurs.

### SUMMARY

An advantage of some aspects of the invention is to provide a pressure sensor capable of reducing the hysteresis, a production method for the pressure sensor, and an altimeter, an electronic apparatus, and a moving object, each of which includes the pressure sensor and has high reliability.

The advantage can be achieved by the following configuration.

A pressure sensor according to an aspect of the invention includes a substrate which has a first silicon layer, a second silicon layer placed on one side of the first silicon layer, and a silicon oxide layer placed between the first silicon layer and the second silicon layer, and a concave section which opens to the surface on the first silicon layer side of the substrate, wherein in a plan view of the substrate, a portion overlapping the concave section of the substrate becomes a diaphragm which is flexurally deformed by receiving a pressure, and the second silicon layer is exposed on the bottom surface of the concave section.

According to this configuration, a pressure sensor capable of reducing the hysteresis is obtained.

In the pressure sensor according to the aspect of the invention, it is preferred that the thickness of the silicon oxide layer is 0.05 μm or more and 0.5 μm or less.

According to this configuration, for example, in the case where the concave section is formed by etching, the thickness can be made sufficient for allowing the silicon oxide layer to function as an etching stopper, and also excessive thickening of the silicon oxide layer can be prevented.

In the pressure sensor according to the aspect of the invention, it is preferred that in a vertical cross-sectional view of the substrate, the width of the concave section on the surface on the silicon oxide layer side of the first silicon layer is smaller than the width of the concave section in the silicon oxide layer.

According to this configuration, the shape of the diaphragm is easily controlled. Further, for example, the concave section is easily formed by etching.

In the pressure sensor according to the aspect of the invention, it is preferred that the pressure sensor includes a pressure reference chamber placed with the diaphragm interposed between the same and the concave section, and the surface on the opposite side to the silicon oxide layer of the second silicon layer is exposed in the pressure reference chamber.

According to this configuration, the diaphragm can be constituted by the second silicon layer, and the hysteresis can be further reduced.

In the pressure sensor according to the aspect of the invention, it is preferred that the diaphragm is constituted by the second silicon layer.

According to this configuration, the hysteresis can be further reduced.

In the pressure sensor according to the aspect of the invention, it is preferred that in the diaphragm, a piezoresistive element is placed.

According to this configuration, the flexure of the diaphragm by receiving a pressure can be detected with a simple configuration.

In the pressure sensor according to the aspect of the invention, it is preferred that in a plan view of the substrate, an end on the peripheral side of the diaphragm of the piezoresistive element is located between the periphery of the diaphragm and the periphery of the concave section on the surface on the silicon oxide layer side of the first silicon layer.

According to this configuration, the piezoresistive element can be placed at a place where stress is likely to be concentrated, and therefore, the flexure of the diaphragm by receiving a pressure can be detected with higher accuracy.

A production method for a pressure sensor according to an aspect of the invention includes preparing a substrate which has a first silicon layer, a second silicon layer placed on one side of the first silicon layer, and a silicon oxide layer placed between the first silicon layer and the second silicon layer, and forming a concave section which opens to the surface on the first silicon layer side of the substrate to expose the second silicon layer on the bottom surface of the concave section, and forming a diaphragm which is flexurally deformed by receiving a pressure in a portion overlapping the concave section of the substrate in a plan view of the substrate.

According to this configuration, a pressure sensor capable of reducing the hysteresis is obtained.

In the production method for a pressure sensor according to the aspect of the invention, it is preferred that the forming the diaphragm includes forming the concave section which opens to the surface on the first silicon layer side of the substrate to expose the silicon oxide layer on the bottom surface by dry etching, and removing a portion exposed on the bottom surface of the concave section of the silicon oxide layer by wet etching.

According to this configuration, the concave section (diaphragm) can be easily and accurately formed.

An altimeter according to an aspect of the invention includes the pressure sensor according to the aspect of the invention.

According to this configuration, an altimeter having high reliability is obtained.

An electronic apparatus according to an aspect of the invention includes the pressure sensor according to the aspect of the invention.

According to this configuration, an electronic apparatus having high reliability is obtained.

A moving object according to an aspect of the invention includes the pressure sensor according to the aspect of the invention.

According to this configuration, a moving object having high reliability is obtained.

### BRIEF DESCRIPTION OF THE DRAWINGS

The invention will be described with reference to the accompanying drawings, wherein like numbers reference like elements.

FIG. 1 is a cross-sectional view of a pressure sensor according to a first embodiment of the invention.

FIG. 2 is a partial enlarged cross-sectional view of the pressure sensor shown in FIG. 1.

FIG. 3 is a plan view showing a pressure sensor section included in the pressure sensor shown in FIG. 1.

FIG. 4 is a view showing a bridge circuit including the pressure sensor section shown in FIG. 3.

FIG. 5 is a flowchart of a production method for the pressure sensor shown in FIG. 1.

FIG. 6 is a cross-sectional view for illustrating the production method for the pressure sensor shown in FIG. 1.

FIG. 7 is a cross-sectional view for illustrating the production method for the pressure sensor shown in FIG. 1.

FIG. 8 is a cross-sectional view for illustrating the production method for the pressure sensor shown in FIG. 1.

FIG. 9 is a cross-sectional view for illustrating the production method for the pressure sensor shown in FIG. 1.

FIG. 10 is a cross-sectional view for illustrating the production method for the pressure sensor shown in FIG. 1.

FIG. 11 is a cross-sectional view for illustrating the production method for the pressure sensor shown in FIG. 1.

FIG. 12 is a cross-sectional view for illustrating the production method for the pressure sensor shown in FIG. 1.

FIG. 13 is a cross-sectional view for illustrating the production method for the pressure sensor shown in FIG. 1.

FIG. 14 is a graph showing the relationship between the over-etching time and the side-etching amount.

FIG. 15 is a cross-sectional view of a pressure sensor according to a second embodiment of the invention.

FIG. 16 is a perspective view showing one example of an altimeter according to the invention.

FIG. 17 is a front view showing one example of an electronic apparatus according to the invention.

FIG. 18 is a perspective view showing one example of a moving object according to the invention.

### DESCRIPTION OF EXEMPLARY EMBODIMENTS

Hereinafter, a pressure sensor, a production method for a pressure sensor, an altimeter, an electronic apparatus, and a moving object according to the invention will be described in detail based on embodiments shown in the accompanying drawings.

### First Embodiment

First, a pressure sensor according to a first embodiment of the invention will be described.

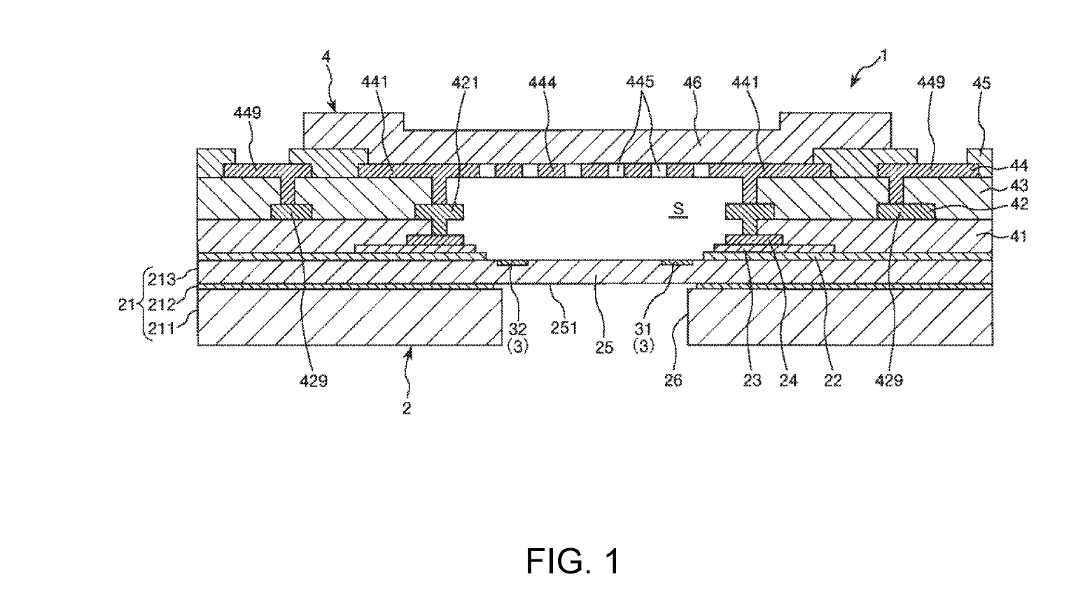

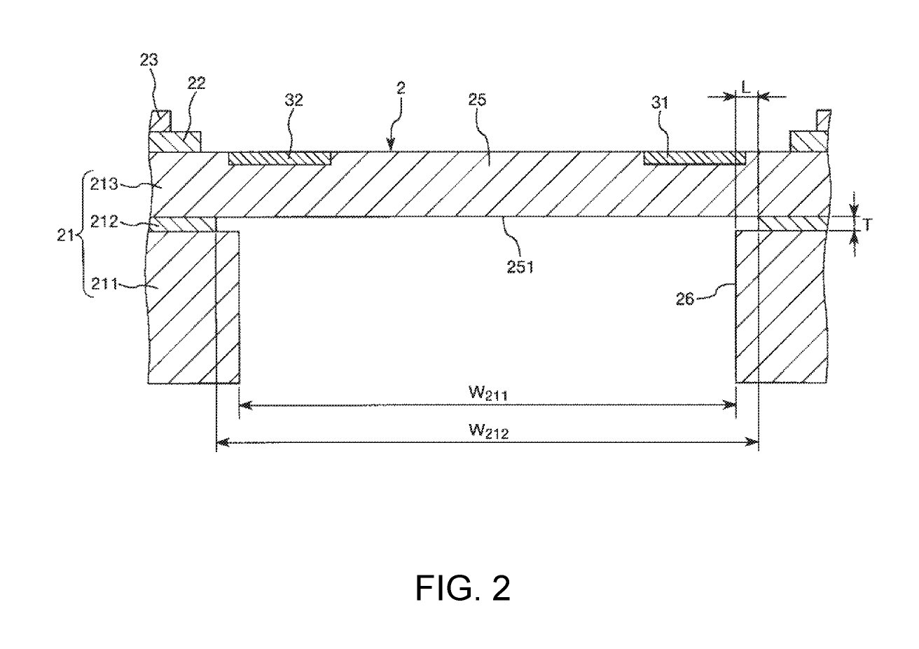

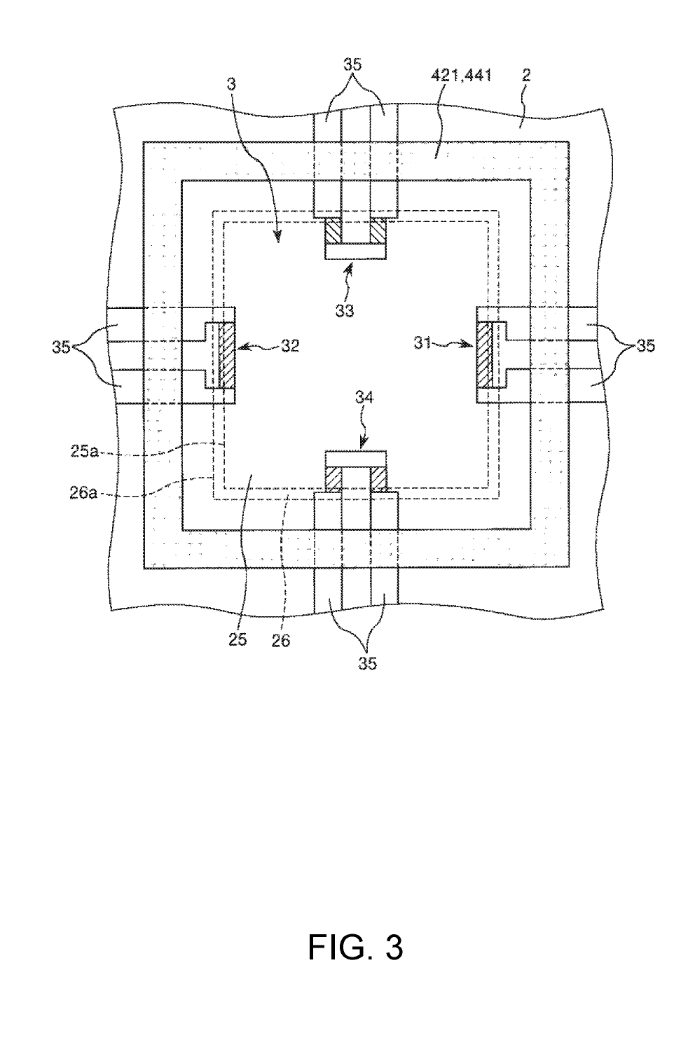

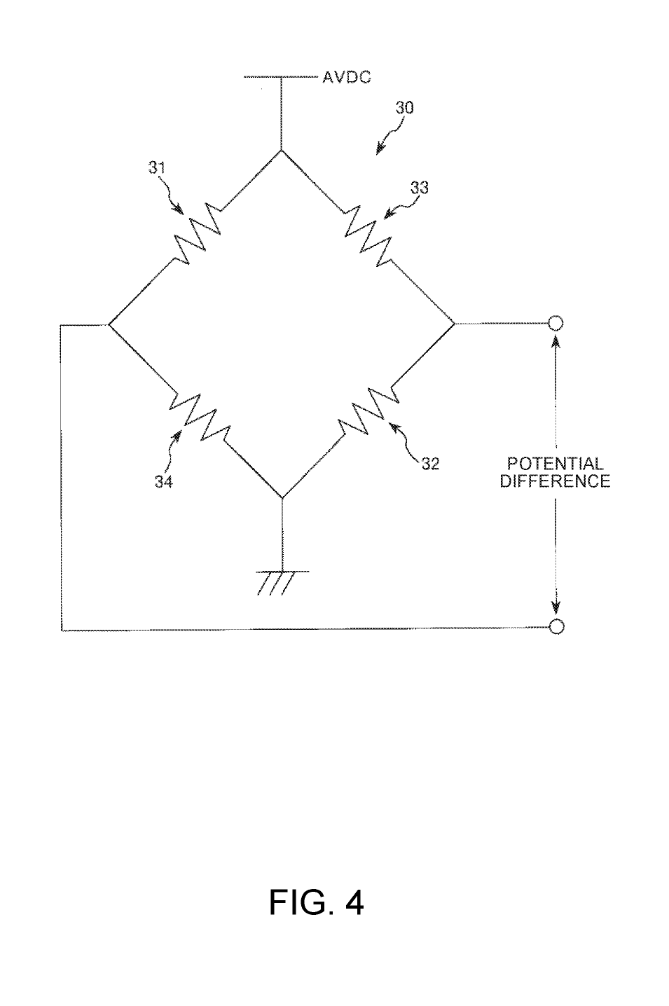

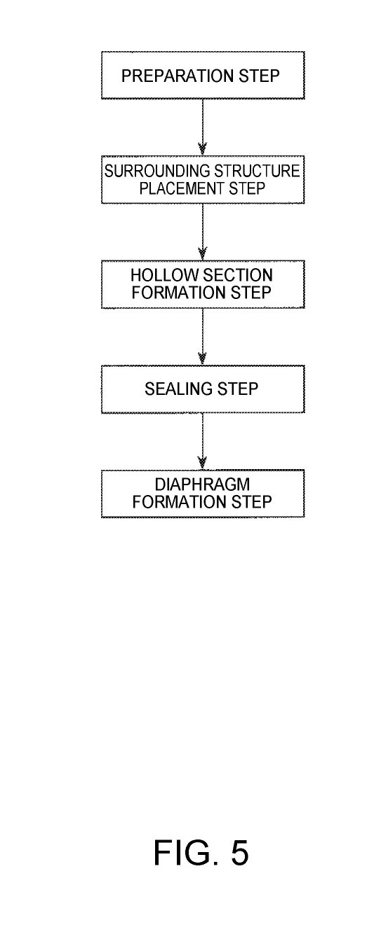

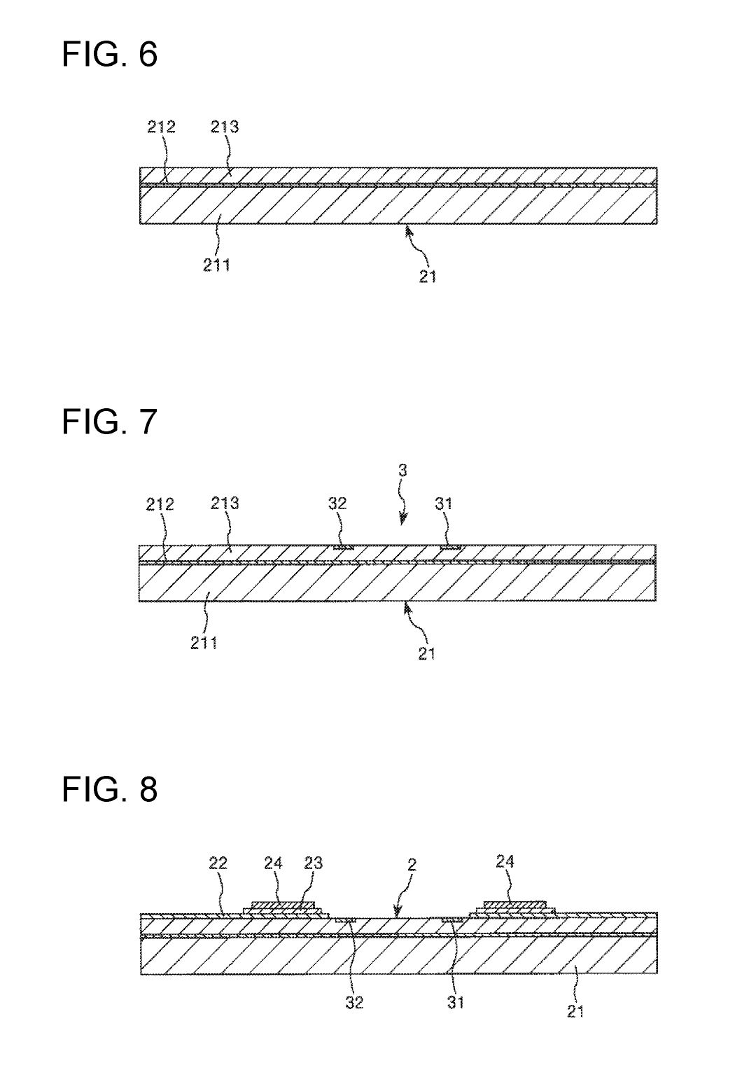

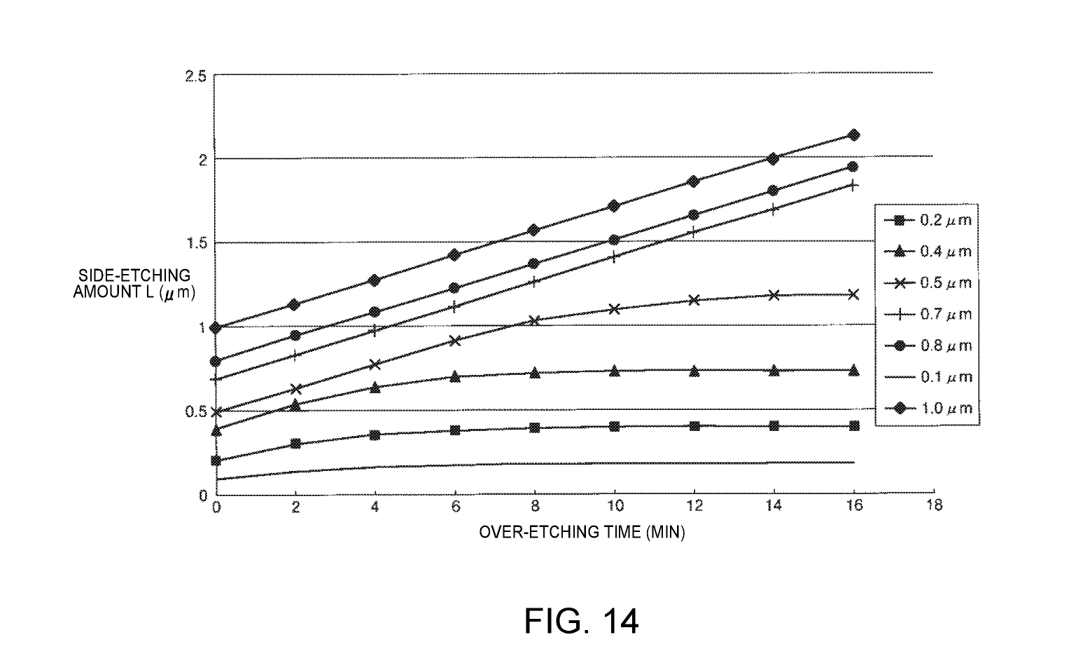

FIG. 1 is a cross-sectional view of the pressure sensor according to the first embodiment of the invention. FIG. 2 is a partial enlarged cross-sectional view of the pressure sensor shown in FIG. 1. FIG. 3 is a plan view showing a pressure sensor section included in the pressure sensor shown in FIG. 1. FIG. 4 is a view showing a bridge circuit including the pressure sensor section shown in FIG. 3. FIG. 5 is a flowchart of a production method for the pressure sensor shown in FIG. 1. FIGS. 6 to 13 are each a cross-sectional view for illustrating the production method for the pressure sensor shown in FIG. 1. FIG. 14 is a graph showing the relationship between the over-etching time and the side-etching amount. In the following description, the upper side and the lower side in FIG. 1 are also referred to as “upper” and “lower”, respectively.

A pressure sensor 1 shown in FIG. 1 includes a base 2, a pressure sensor section 3, a surrounding structure 4, and a hollow section S. Hereinafter, the respective sections will be sequentially described.

### Base

As shown in FIG. 1, the base 2 is constituted by stacking (forming) a first insulating film 22 constituted by a silicon oxide film (SiO₂ film), a second insulating film 23 constituted by a silicon nitride film (SiN film), and a polysilicon film 24 in this order on an SOI substrate (substrate) 21. Further, the SOI substrate 21 has a first silicon layer 211, a second silicon layer 213 placed on the upper side of the first silicon layer 211, and a silicon oxide layer 212 placed between the first and second silicon layers 211 and 213. The first insulating film 22, the second insulating film 23, and the polysilicon film 24 may be provided as needed and may be omitted.

Further, in the base 2, a diaphragm 25 which is thinner than the peripheral portion and is flexurally deformed by receiving a pressure is provided. By providing a bottomed concave section 26 which opens to the lower surface (the surface on the first silicon layer 211 side) of the SOI substrate 21, this diaphragm 25 is formed on a bottom portion of the concave section 26 (a portion overlapping the concave section 26 in a plan view of the base 2). Then, the lower surface (the bottom surface of the concave section 26) of the diaphragm 25 becomes a pressure receiving surface 251. The thickness of such a diaphragm 25 is not particularly limited, but is preferably set to about 1.5 μm or more and 2.0 μm or less. According to this, the diaphragm 25 which is easily flexed while sufficiently maintaining the mechanical strength is formed.

Here, in the base 2, the second silicon layer 213 is exposed on the bottom surface of the concave section 26. In other words, the bottom surface of the concave section 26 is constituted by the lower surface of the second silicon layer 213. Further, in a plan view of the base 2, the first and second insulating films 22 and 23 are placed so as not to overlap the diaphragm 25, and the second silicon layer 213 is exposed in the hollow section S as the upper surface of the diaphragm 25. According to such a configuration, the diaphragm 25 can be constituted substantially only by the second silicon layer 213. By constituting the diaphragm 25 by a single layer (a single material) in this manner, the hysteresis problem (a phenomenon in which even if the same pressure is received, the measured value varies depending on the environmental temperature) caused in the case where a diaphragm is constituted by a plurality of layers composed of different materials as in the “Related Art” described above hardly occurs. Due to this, according to the pressure sensor 1, the hysteresis can be reduced, and the decrease in the pressure detection accuracy can be effectively reduced.

In this embodiment, a configuration in which the diaphragm 25 is constituted only by the second silicon layer 213 is described, however, for example, at least the first insulating film 22 of the first and second insulating films 22 and 23 may be placed in the diaphragm 25 as long as the silicon oxide layer 212 is not placed at least on the lower surface side of the diaphragm 25, that is, as long as the second silicon layer 213 is exposed on the bottom surface of the concave section 26. By placing the first and second insulating films 22 and 23 on the diaphragm 25, the effect of reducing the hysteresis as described above is decreased as compared with this embodiment, however, the decreasing level is smaller than in the case where the silicon oxide layer 212 is included in the diaphragm 25 (that is, the related art). The reason for this is as follows. Firstly, the film thickness of each of the first and second insulating films 22 and 23 is thinner than that of the silicon oxide layer 212, and the internal stress due to the differences in the linear expansion coefficient among the second silicon layer 213, the first insulating film 22, and the second insulating film 23 hardly occurs (even if the internal stress occurs, it is small). Secondary, the linear expansion coefficient of the first insulating film (SiO₂ film) 22 located in the middle of the three layers is smaller than the linear expansion coefficients of the second silicon layer 213 and the second insulating film (SiN film) 23 located on both sides thereof, and also the difference in the linear expansion coefficient between the second silicon layer 213 and the second insulating film 23 is relatively small. By interposing the first insulating film 22 between the second silicon layer 213 and the second insulating film 23 whose difference in the linear expansion coefficient is small in this manner, the internal stress due to the difference in the linear expansion coefficient hardly occurs (even if the internal stress occurs, it is small). The linear expansion coefficients of the second silicon layer 213, the first insulating film 22, and the second insulating film 23 are 3.9×10⁻⁶/K, 0.65×10⁻⁶/K, and 2.4×10⁻⁶/K, respectively.

When describing the configuration of the concave section 26 in detail, as shown in FIG. 2, the concave section 26 in the first silicon layer 211 has a straight shape such that the width in the thickness direction (transverse cross-sectional area) thereof is almost constant. Further, in a vertical cross-sectional view of the base 2 (the cross section in FIG. 1), the width W₂₁₁ of the concave section 26 on the upper surface (the surface on the silicon oxide layer 212 side) of the first silicon layer 211 is smaller than the width W₂₁₂ of the concave section 26 in the silicon oxide layer 212. That is, in a plan view of the base 2, the contour of the concave section 26 in the silicon oxide layer 212 is located on the outside so as to surround the contour of the concave section 26 on the upper surface of the first silicon layer 211. According to such a configuration, the outer shape of the diaphragm 25 can be made to match the shape of the concave section 26 in the silicon oxide layer 212. Due to this, as will be described later in the production method, the outer shape of the diaphragm 25 is easily controlled, and therefore, the diaphragm 25 having a desired outer shape (particularly, size) can be more accurately formed.

As a method for forming the concave section 26 into the above-mentioned shape, as will also be described later in the production method, a method in which first, a concave section is formed in the first silicon layer 211 by dry etching (silicon deep etching), and subsequently, a portion of the silicon oxide layer 212 exposed on the bottom surface of the concave section is removed by wet etching is exemplified. According to such a method, the concave section 26 having the above-mentioned shape can be relatively easily formed. Incidentally, the silicon oxide layer 212 functions as an etching stopper when the concave section is formed in the first silicon layer 211 by dry etching.

Here, the thickness T of the silicon oxide layer 212 is not particularly limited, and is preferably 0.05 μm or more and 0.5 μm or less. By setting the film thickness of the silicon oxide layer 212 within such a range, the thickness can be made sufficient for allowing the silicon oxide layer 212 to function as the etching stopper described above, and also excessive thickening of the silicon oxide layer 212 can be prevented. Moreover, as will be described later in the production method, the side-etching amount L of the silicon oxide layer 212 when the silicon oxide layer 212 is wet-etched can be accurately controlled, and therefore, the diaphragm 25 having a desired outer shape can be more accurately formed.

Hereinabove, the configuration of the base 2 is described. In such a base 2, in the SOI substrate 21 (second silicon layer 213), the pressure sensor section 3, a semiconductor circuit (circuit) (not shown) electrically connected to the pressure sensor section 3, etc. are fabricated. In this semiconductor circuit, circuit elements such as an active element (such as an MOS transistor) formed as needed, a capacitor, an inductor, a resistor, a diode, and a wiring are included. However, such a semiconductor circuit may be omitted.

### Pressure Sensor Section

As shown in FIG. 3, the pressure sensor section 3 includes four piezoresistive elements 31, 32, 33, and 34 (portions indicated by hatching in FIG. 3) provided in the diaphragm 25. The piezoresistive elements 31, 32, 33, and 34 are electrically connected to one another through a wiring 35 or the like and constitute a bridge circuit 30 (Wheatstone bridge circuit) shown in FIG. 4, which is connected to the semiconductor circuit.

To the bridge circuit 30, a drive circuit (not shown) which supplies a drive voltage AVDC is connected. Then, the bridge circuit 30 outputs a signal (voltage) in accordance with the change in the resistance value of the piezoresistive element 31, 32, 33, or 34 based on the flexure of the diaphragm 25. Due to this, a pressure received by the diaphragm 25 can be detected based on this output signal.

Each of the piezoresistive elements 31, 32, 33, and 34 is constituted by, for example, doping (diffusing or injecting) an impurity such as phosphorus or boron into the second silicon layer 213. A wiring for connecting these piezoresistive elements 31 to 34 to one another is constituted by, for example, doping (diffusing or injecting) an impurity such as phosphorus or boron into the second silicon layer 213 at a higher concentration than in the piezoresistive elements 31 to 34.

Further, in a plan view of the base 2, the end on the peripheral side of the diaphragm 25 of each of the piezoresistive elements 31, 32, 33, and 34 is located between the periphery 25a of the diaphragm 25 and the periphery 26a of the concave section 26 on the upper surface (the surface on the silicon oxide layer 212 side) of the first silicon layer 211. In other words, the piezoresistive elements 31, 32, 33, and 34 are located in the diaphragm 25 and also placed extending over the periphery 26a. According to such a configuration, the piezoresistive elements 31, 32, 33, and 34 can be placed in the end portions of the diaphragm 25. The end portions of the diaphragm 25 are regions in which stress is likely to be concentrated when the diaphragm 25 is flexurally deformed by receiving a pressure, and therefore, by placing the piezoresistive elements 31, 32, 33, and 34 in such portions, the output signal from the pressure sensor section 3 is increased, and thus, the pressure detection accuracy can be increased.

### Hollow Section

As shown in FIG. 1, the hollow section S is defined by being surrounded by the base 2 and the surrounding structure 4. Such a hollow section S is a hermetically sealed space and functions as a pressure reference chamber which provides a reference value of a pressure to be detected by the pressure sensor 1. Further, the hollow section S is located on the opposite side to the pressure receiving surface 251 of the diaphragm 25 and is placed so as to overlap the diaphragm 25. That is, the hollow section S is located with the diaphragm 25 interposed between the same and the concave section 26. The hollow section S is preferably in a vacuum state (for example, about 10 Pa or less). According to this, the pressure sensor 1 can be used as a so-called “absolute pressure sensor” which detects a pressure with reference to vacuum, and the pressure sensor 1 has high convenience. However, the hollow section S may not be in a vacuum state as long as the pressure is kept constant therein.

### Surrounding Structure

As shown in FIG. 1, the surrounding structure 4 which defines the hollow section S along with the base 2 includes an interlayer insulating film 41, a wiring layer 42 placed on the interlayer insulating film 41, an interlayer insulating film 43 placed on the wiring layer 42 and the interlayer insulating film 41, a wiring layer 44 placed on the interlayer insulating film 43, a surface protective film 45 placed on the wiring layer 44 and the interlayer insulating film 43, and a sealing layer 46 placed on the wiring layer 44 and the surface protective film 45.

The wiring layer 42 includes a frame-shaped wiring section 421 placed so as to surround the hollow section S and a circuit wiring section 429 which constitutes a wiring for the semiconductor circuit. Similarly, the wiring layer 44 includes a frame-shaped wiring section 441 placed so as to surround the hollow section S and a circuit wiring section 449 which constitutes a wiring for the semiconductor circuit. Then, the semiconductor circuit is drawn out on the upper surface of the surrounding structure 4 by the circuit wiring sections 429 and 449.

Further, as shown in FIG. 1, the wiring layer 44 includes a coating layer 444 located on the ceiling of the hollow section S. Then, in the coating layer 444, a plurality of through-holes (pores) 445 communicating inside and outside the hollow section S are provided. Such a coating layer 444 is provided extending toward the ceiling of the hollow section S from the wiring section 441 and is placed so as to face the diaphragm 25 with the hollow section S interposed therebetween. The plurality of through-holes 445 are holes for release etching through which an etching solution is allowed to penetrate into the hollow section S as will be described later in the production method. Further, on the coating layer 444, the sealing layer 46 is placed, and the through-holes 445 are sealed by the sealing layer 46.

The surface protective film 45 has a function to protect the surrounding structure 4 from water, dust, scratches, etc. Such a surface protective film 45 is placed on the interlayer insulating film 43 and the wiring layer 44 so as not to close the through-holes 445 of the coating layer 444.

In such a surrounding structure 4, as the interlayer insulating films 41 and 43, for example, an insulating film such as a silicon oxide film (SiO₂ film) can be used. Further, as the wiring layers 42 and 44, for example, a metal film such as an aluminum film can be used. In addition, as the sealing layer 46, for example, a metal film of Al, Cu, W, Ti, TiN, or the like, a silicon oxide film, or the like can be used. As the surface protective film 45, for example, a silicon oxide film, a silicon nitride film, a polyimide film, an epoxy resin film, or the like can be used.

Next, a production method for the pressure sensor 1 will be described. As shown in FIG. 5, the production method for the pressure sensor 1 includes a preparation step of preparing the base 2, a surrounding structure 4 placement step of placing the surrounding structure on the base 2, a hollow section formation step of forming a hollow section S, a sealing step of sealing the hollow section S, and a diaphragm formation step of forming the diaphragm 25.

### Preparation Step

First, as shown in FIG. 6, the SOI substrate 21 in which the first silicon layer 211, the silicon oxide layer 212, and the second silicon layer 213 are stacked is prepared. Subsequently, as shown in FIG. 7, the pressure sensor section 3 is formed by injecting an impurity such as phosphorus or boron into the upper surface of the SOI substrate 21. Subsequently, as shown in FIG. 8, the first insulating film 22, the second insulating film 23, and the polysilicon film 24 are sequentially formed on the SOI substrate 21 using a sputtering method, a CVD method, or the like. By doing this, the base 2 in a state where the diaphragm 25 (concave section 26) is not formed is obtained.

### Surrounding Structure Placement Step

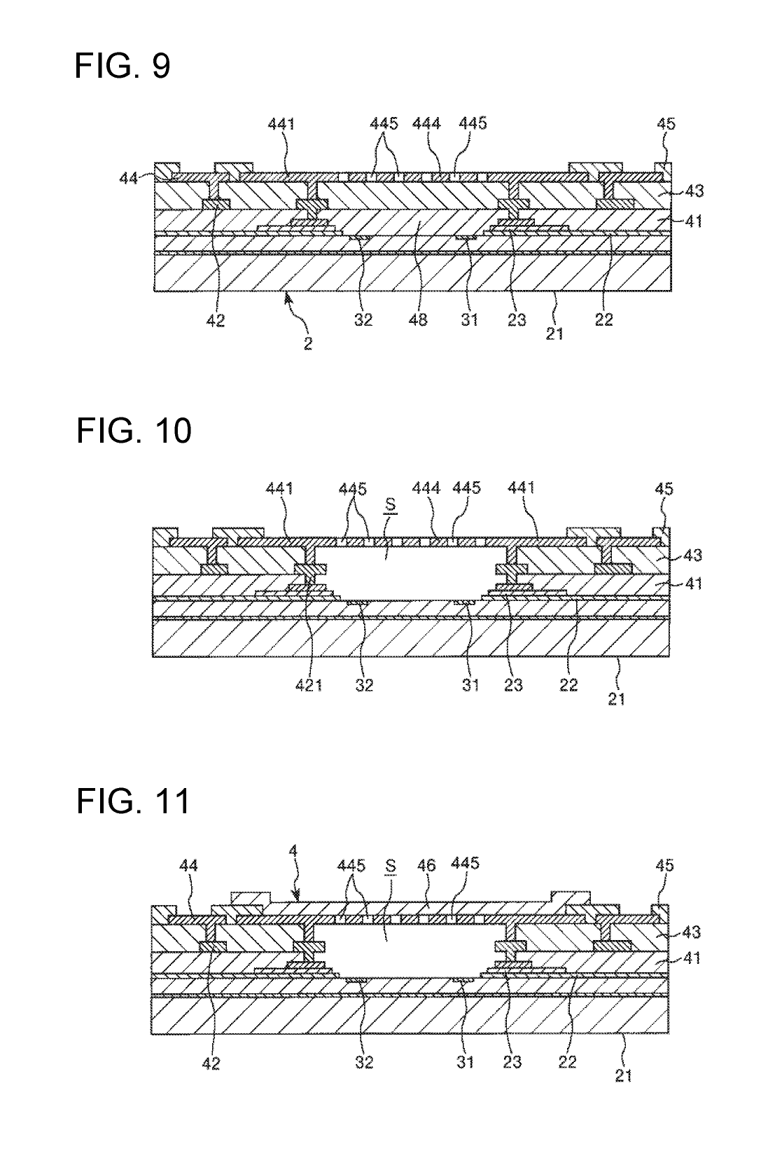

Subsequently, as shown in FIG. 9, the interlayer insulating film 41, the wiring layer 42, the interlayer insulating film 43, the wiring layer 44, and the surface protective film 45 are sequentially formed on the base 2 using a sputtering method, a CVD method, or the like. By doing this, a sacrificial layer 48 is formed so as to fill the hollow section S between the base 2 and the coating layer 444.

### Hollow Section Formation Step

Subsequently, as shown in FIG. 10, the base 2 is, for example, exposed to an etching solution such as buffered hydrofluoric acid in a state where the surface protective film 45 is protected with a resist mask (not shown). By doing this, the sacrificial layer 48 is release-etched through the through-holes 445, whereby the hollow section S is formed.

### Sealing Step

Subsequently, as shown in FIG. 11, the hollow section S is brought into a vacuum state, and the sealing layer 46 is formed on the coating layer 444 using a sputtering method, a CVD method, or the like, whereby the hollow section S is sealed with the sealing layer 46. By doing this, the hollow section S in a vacuum state is obtained.

### Diaphragm Formation Step

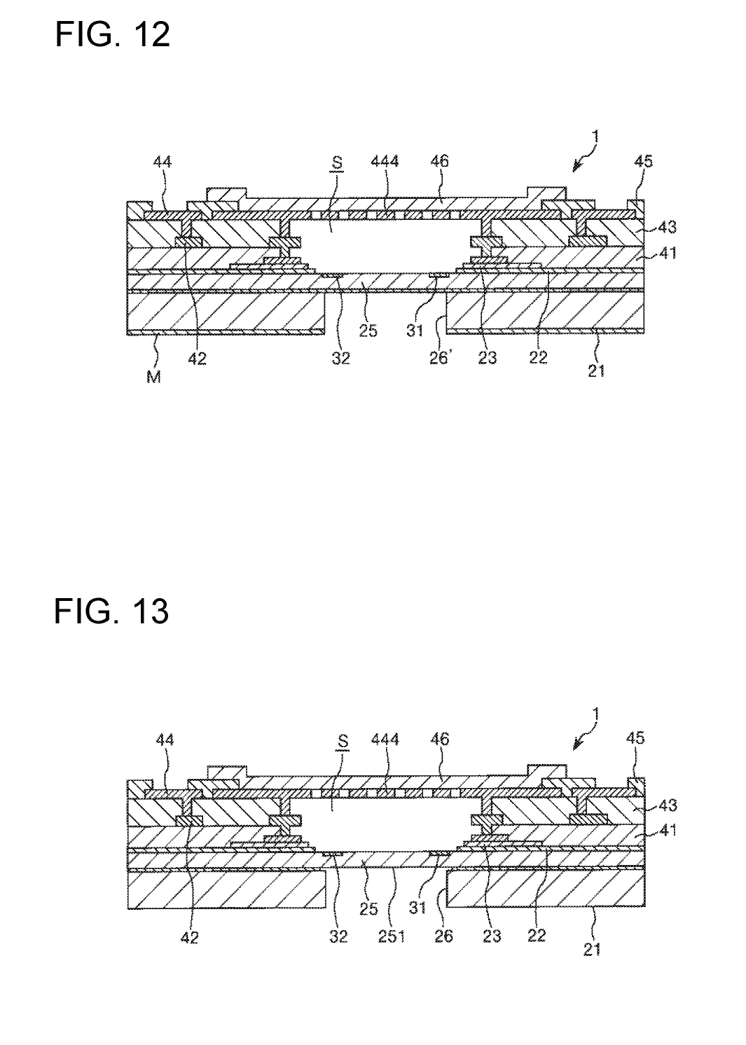

Subsequently, a mask (for example, a resist mask) M having an opening corresponding to the concave section 26 is formed on the lower surface of the SOI substrate 21. Subsequently, as shown in FIG. 12, a concave section 26′ is formed by dry etching the first silicon layer 211 through the mask M. Here, by using a known silicon deep etching apparatus, the first silicon layer 211 is engraved from the lower surface (the surface of the first silicon layer 211) side of the SOI substrate 21 by repeating a step of isotropic etching, formation of a protective film, and anisotropic etching. When the etching of the first silicon layer 211 proceeds and reaches the silicon oxide layer 212, the silicon oxide layer 212 serves as an etching stopper, and therefore, etching does not proceed any further. By doing this, the concave section 26′ (an unfinished concave section 26) is formed. According to such a method, the shape of the bottom surface of the concave section 26′ can be controlled according to the shape of the opening of the mask M, and therefore, the concave section 26′ can be more accurately formed into a desired shape. Incidentally, by dry etching by repeating the step of isotropic etching, formation of a protective film, and anisotropic etching, periodic fine irregularities are formed in the engraving direction on the side surface of the inner wall of the concave section 26′.

Subsequently, the mask M remaining on the lower surface of the SOI substrate 21 is removed by asking using an oxygen plasma, and further, the protective film (for example, a fluorocarbon compound film) adhered to the side surface of the concave section 26′ is removed using a fluorine-based solvent. Subsequently, as shown in FIG. 13, by using the first silicon layer 211 as a mask, the silicon oxide layer 212 exposed on the bottom surface of the concave section 26′ is wet-etched. When the wet etching proceeds and reaches the second silicon layer 213, the second silicon layer 213 serves as an etching stopper, and therefore, etching does not proceed any further. By doing this, the concave section 26, in which the second silicon layer 213 is exposed on the bottom surface is formed, and the diaphragm 25 is obtained on the bottom portion thereof. Here, the wet etching for removing the silicon oxide layer 212 is isotropic etching, and therefore, the silicon oxide layer 212 is etched (side-etched) also in the lateral direction (in-plane direction), and as a result, the width W₂₁₂ of the concave section 26 in the silicon oxide layer 212 is larger than the width W₂₁₁ of the concave section 26 on the upper surface of the first silicon layer 211 as described above.

Here, as described above, the thickness T of the silicon oxide layer 212 is preferably 0.05 μm or more and 0.5 μm or less. According to this, the thickness can be made sufficient for allowing the silicon oxide layer 212 to function as an etching stopper, and also excessive thickening of the silicon oxide layer 212 can be prevented. Moreover, the side-etching amount described above can be accurately controlled. FIG. 14 is a graph showing the relationship between the over-etching time (an elapsed time from completion of etching to a depth corresponding to the thickness of the silicon oxide layer 212) and the side-etching amount L with respect to the silicon oxide layer 212 having a different thickness T. As found from this graph, in the case of the silicon oxide layer 212 having a thickness T of 0.1 μm or more and 0.5 μm or less, side-etching is stopped when the over-etching time is relatively short (within 15 minutes), and thereafter, an almost constant side-etching amount L is maintained. In this manner, by stopping side-etching, the maximum value of the side-etching amount L can be easily controlled. Due to this, for example, by setting the size of the concave section 26′ in accordance with the maximum value of the side-etching amount L, and further, by setting the over-etching time so as to obtain the maximum value of the side-etching amount L, the diaphragm 25 having a desired size can be accurately formed.

As described above, the pressure sensor 1 is obtained. According to such a production method, the pressure sensor 1 capable of reducing the hysteresis and also capable of effectively reducing the decrease in the pressure detection accuracy can be easily produced. In particular, according to the production method for the concave section 26 as described above, the diaphragm 25 can be accurately formed.

### Second Embodiment

Next, a pressure sensor according to a second embodiment of the invention will be described.

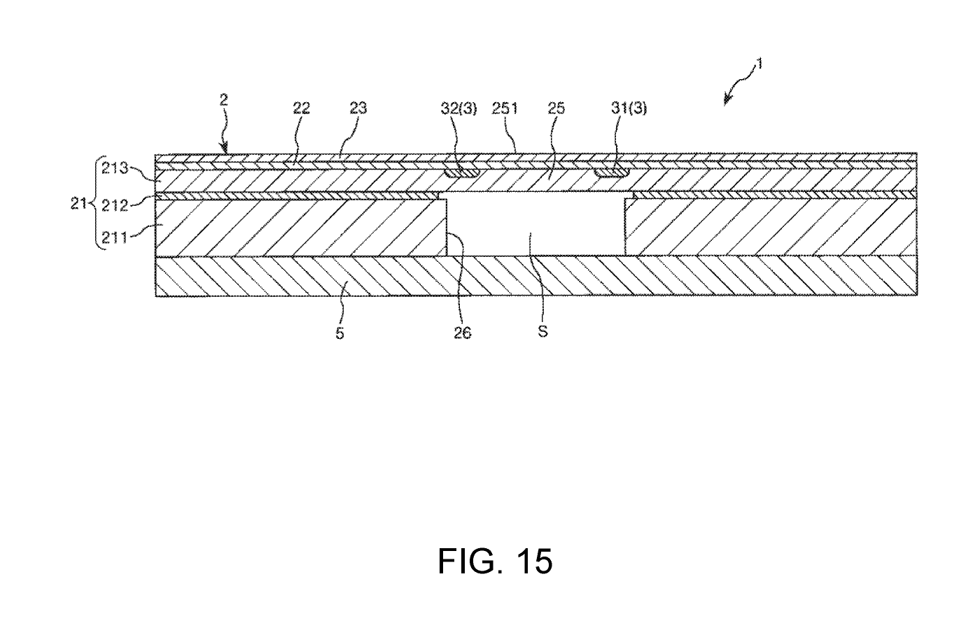

FIG. 15 is a cross-sectional view of the pressure sensor according to the second embodiment of the invention.

Hereinafter, with respect to the pressure sensor according to the second embodiment, different points from the above-mentioned embodiment will be mainly described, and the description of the same matter will be omitted. The same components as those of the above-mentioned embodiment are denoted by the same reference numerals.

As shown in FIG. 15, in the pressure sensor 1 of this embodiment, instead of omitting the surrounding structure 4 which is included in the above-mentioned first embodiment, a plate-shaped lid section 5 is bonded to the lower surface of the base 2 (SOI substrate 21) so as to close the opening of the concave section 26, and the hollow section (pressure reference chamber) S is formed between the base 2 and the lid section 5. In the pressure sensor 1 having such a configuration, a region overlapping the hollow section S of the base 2 becomes the diaphragm 25, and the upper surface of the diaphragm 25 becomes the pressure receiving surface 251. The lid section 5 can be constituted by, for example, a silicon substrate.

Also, according to such a second embodiment, the same effect as that of the above-mentioned first embodiment can be exhibited.

### Third Embodiment

Next, an altimeter according to a third embodiment of the invention will be described.

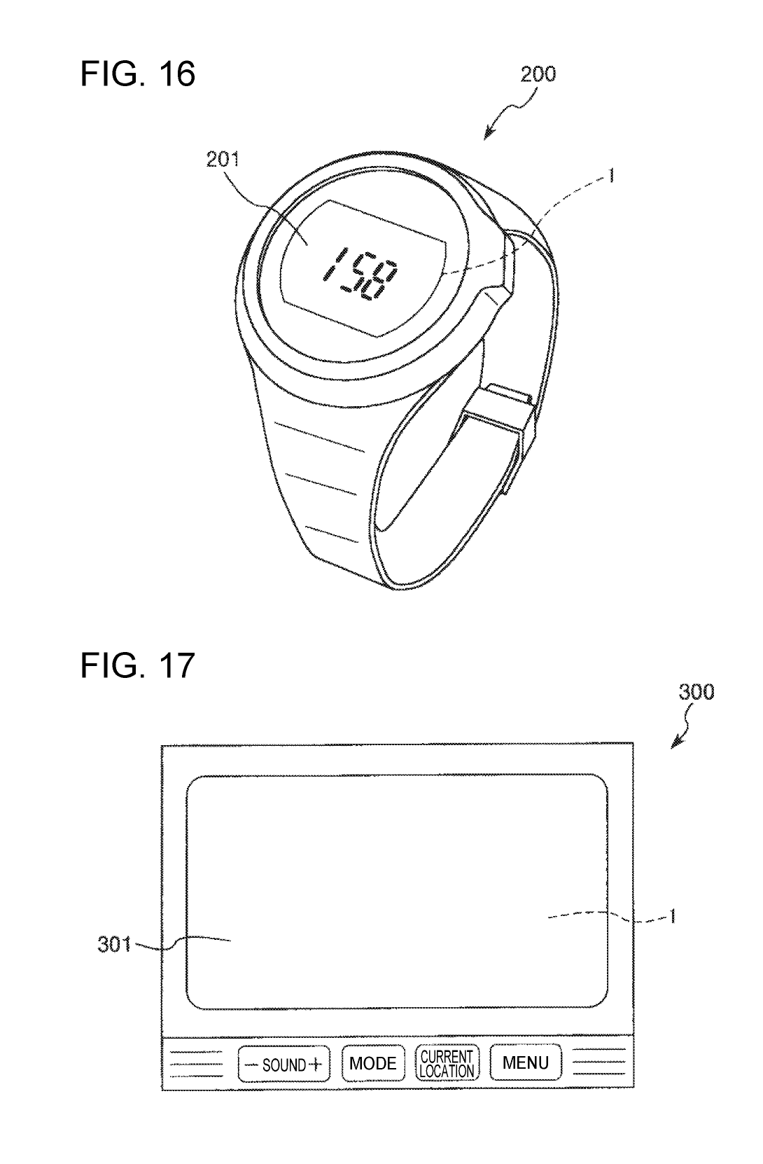

FIG. 16 is a perspective view showing one example of an altimeter according to the invention.

As shown in FIG. 16, an altimeter 200 can be worn on the wrist like a wristwatch. In the altimeter 200, the pressure sensor 1 is mounted, and the altitude of the current location above sea level or the atmospheric pressure of the current location, or the like can be displayed on a display section 201. In this display section 201, various information such as a current time, the heart rate of a user, or weather can be displayed. Such an altimeter 200 includes the pressure sensor 1, and therefore can exhibit high reliability.

### Fourth Embodiment

Next, an electronic apparatus according to a fourth embodiment of the invention will be described.

FIG. 17 is a front view showing one example of an electronic apparatus according to the invention.

The electronic apparatus according to this embodiment is a navigation system 300 including the pressure sensor 1. As shown in FIG. 17, the navigation system 300 includes map information (not shown), a location information acquisition unit based on a GPS (Global Positioning System), a self-contained navigation unit based on a gyroscope, an accelerometer, and a vehicle speed data, the pressure sensor 1, and a display section 301 which displays given location information or route information.

According to this navigation system 300, in addition to the acquired location information, altitude information can be acquired. For example, in the case where a vehicle travels on an elevated road which is shown at the same position as a general road on the location information, it cannot be determined whether the vehicle travels on the general road or the elevated road. Therefore, by mounting the pressure sensor 1 in the navigation system 300, and detecting the change in altitude by entering the elevated road from the general road (or vice versa), it is possible to determine whether the vehicle travels on the general road or the elevated road, and the navigation information of the actual traveling state can be provided to a user. Such a navigation system 300 includes the pressure sensor 1, and therefore can exhibit high reliability.

The electronic apparatus including the pressure sensor according to the invention is not limited to the above-mentioned navigation system, and can be applied to, for example, a personal computer, a cellular phone, a smartphone, a tablet terminal, a timepiece (including a smart watch), a medical apparatus (for example, an electronic thermometer, a sphygmomanometer, a blood glucose meter, an electrocardiographic apparatus, an ultrasonic diagnostic apparatus, or an electronic endoscope), various measurement apparatuses, meters and gauges (for example, meters and gauges for vehicles, aircrafts, and ships), a flight simulator, and the like.

### Fifth Embodiment

Next, a moving object according to a fifth embodiment of the invention will be described.

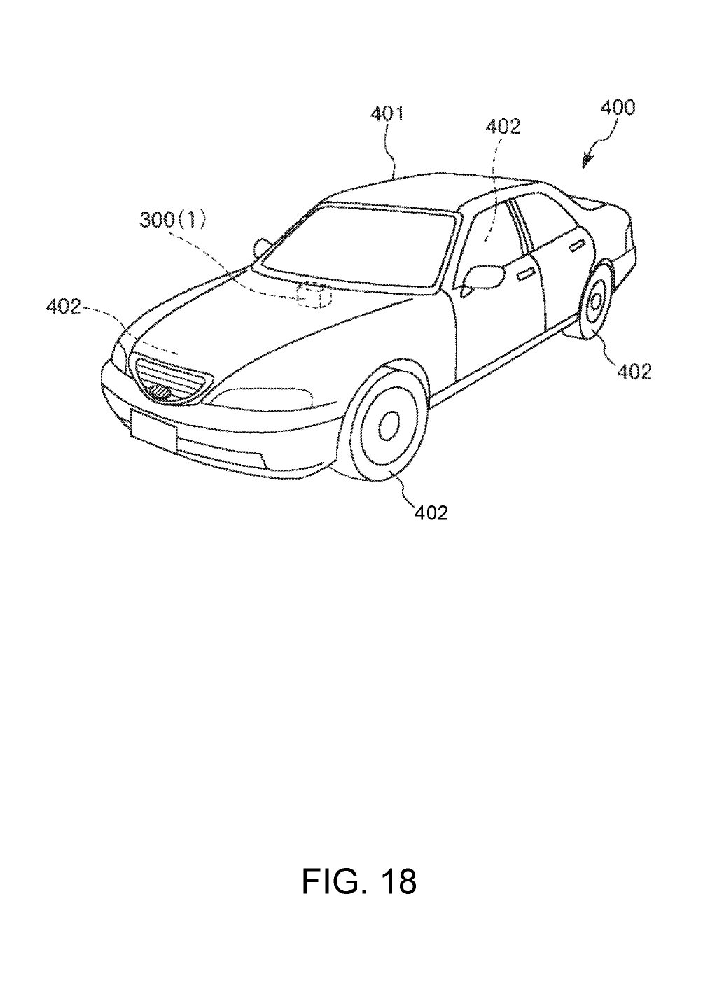

FIG. 18 is a perspective view showing one example of a moving object according to the invention.

The moving object according to this embodiment is a car 400 including the pressure sensor 1. As shown in FIG. 18, the car 400 includes a car body 401 and four wheels 402, and is configured to rotate the wheels 402 by a power source (engine) (not shown) provided in the car body 401. In such a car 400, the navigation system 300 (pressure sensor 1) is included. Such a car 400 includes the pressure sensor 1, and therefore can exhibit high reliability.

Hereinabove, the pressure sensor, the production method for a pressure sensor, the altimeter, the electronic apparatus, and the moving object according to the invention have been described based on the respective embodiments shown in the drawings, however, the invention is not limited thereto, and the configuration of each section can be replaced with an arbitrary configuration having the same function. Further, another arbitrary component or step may be added, and also the respective embodiments maybe appropriately combined with each other.

Further, in the above-mentioned embodiments, as the pressure sensor section, a pressure sensor section using a piezoresistive element is described, however, the pressure sensor is not limited thereto, and for example, a configuration using a flap-type vibrator, another MEMS vibrator such as a

comb electrode, or a vibration element such as a crystal vibrator can also be used.

The entire disclosure of Japanese Patent Application No. 2016-036184, filed Feb. 26, 2016 is expressly incorporated by reference herein.

What is claimed is:

1. A pressure sensor, comprising:
a substrate which has a first silicon layer, a second silicon layer placed on one side of the first silicon layer, and a silicon oxide layer placed between the first silicon layer and the second silicon layer; and
a concave section which opens to the surface on the first silicon layer side of the substrate, wherein
in a plan view of the substrate, a portion overlapping the concave section of the substrate becomes a diaphragm which is flexurally deformed by receiving a pressure, and
the second silicon layer is exposed on the bottom surface of the concave section.

2. The pressure sensor according to claim 1, wherein the thickness of the silicon oxide layer is 0.05 μm or more and 0.5 μm or less.

3. The pressure sensor according to claim 1, wherein in a vertical cross-sectional view of the substrate, the width of the concave section on the surface on the silicon oxide layer side of the first silicon layer is smaller than the width of the concave section in the silicon oxide layer.

4. The pressure sensor according to claim 1, wherein
the pressure sensor includes a pressure reference chamber placed with the diaphragm interposed between the same and the concave section, and
the surface on the opposite side to the silicon oxide layer of the second silicon layer is exposed in the pressure reference chamber.

5. The pressure sensor according to claim 1, wherein the diaphragm is constituted by the second silicon layer.

6. The pressure sensor according to claim 1, wherein in the diaphragm, a piezoresistive element is placed.

7. The pressure sensor according to claim 6, wherein in a plan view of the substrate, an end on the peripheral side of the diaphragm of the piezoresistive element is located between the periphery of the diaphragm and the periphery of the concave section on the surface on the silicon oxide layer side of the first silicon layer.

8. A production method for a pressure sensor, comprising:
preparing a substrate which has a first silicon layer, a second silicon layer placed on one side of the first silicon layer, and a silicon oxide layer placed between the first silicon layer and the second silicon layer; and
forming a concave section which opens to the surface on the first silicon layer side of the substrate to expose the second silicon layer on the bottom surface of the concave section, and forming a diaphragm which is flexurally deformed by receiving a pressure in a portion overlapping the concave section of the substrate in a plan view of the substrate.

9. The production method for a pressure sensor according to claim 8, wherein
the forming the diaphragm includes
forming the concave section which opens to the surface on the first silicon layer side of the substrate to expose the silicon oxide layer on the bottom surface by dry etching, and
removing a portion exposed on the bottom surface of the concave section of the silicon oxide layer by wet etching.

10. An altimeter, comprising the pressure sensor according to claim 1.

11. An altimeter, comprising the pressure sensor according to claim 2.

12. An altimeter, comprising the pressure sensor according to claim 3.

13. An altimeter, comprising the pressure sensor according to claim 4.

14. An electronic apparatus, comprising the pressure sensor according to claim 1.

15. An electronic apparatus, comprising the pressure sensor according to claim 2.

16. An electronic apparatus, comprising the pressure sensor according to claim 3.

17. An electronic apparatus, comprising the pressure sensor according to claim 4.

18. A moving object, comprising the pressure sensor according to claim 1.

19. A moving object, comprising the pressure sensor according to claim 2.

20. A moving object, comprising the pressure sensor according to claim 3.
